(19) United States
(12) Patent Application Publication
(10) Pub. No.: US 2021/0351993 A1
(43) Pub. Date: Nov. 11, 2021

(54) METHODS AND APPARATUS FOR ANALYTICS FUNCTION DISCOVERY

(71) Applicant: Telefonaktiebolaget LM Ericsson (publ), Stockholm (SE)

(72) Inventor: Miguel Angel Puente Pestaña, Madrid (ES)

(21) Appl. No.: 17/282,879

(22) PCT Filed: Oct. 1, 2019
(86) PCT No.: PCT/EP2019/076576

§ 371 Date: Apr. 5, 2021

(30) Foreign Application Priority Data
Oct. 5, 2018 (EP) 18382706.2

(51) Int. Cl. H04L 12/24

(52) U.S. Cl. CPC H04L 41/5058; H04L 41/5051; H04L 41/046

(57) ABSTRACT

Embodiments described herein provide methods and apparatus for analytics function discovery in a service based architecture comprising a network function. A method, in an analytics discovery function, ADF, comprises receiving a request from the network function for requested analytics information; determining whether the requested analytics information matches a first registration entry; wherein the requested analytics information matches the first registration information if the request analytics information matches first analytics information in the first registration entry; and responsive to the requested analytics information matching the first registration entry, selecting the first analytics function in the first registration entry.

### TECHNICAL FIELD

Embodiments described herein relate to methods and apparatus for discovery of analytics functions in a service based architecture network, and for transmitting analytics information requests to such analytics functions. In particular, embodiments described herein provide an analytics discovery function configured to resolve discovery requests and requests for particular analytics information.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly, as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

5G telecommunication networks are being developed which make use of a service based architecture (SBA). FIG. 1 illustrates an example of a reference SBA network.

The Public Land Mobile Network 100 comprises a number of network functions (NFs). In this example the NFs illustrated are a Network Slice Selection Function (NSSF), a Network Exposure Function (NEF), a NF Repository Function (NRF), a Policy Control Function (PCF), a Unified Data Management (UDM) function, an Application Function (AF), an Access and Mobility Management Function (AMF), a Session Management Function (SMF), an Authentication Server Function (AUSF) and a User Plane Function (UPF). A User Equipment (UE) may then connect to this 5GC network via the Radio Access Network (RAN).

FIG. 2 illustrates a reference 3GPP architecture for charging and analytics. In particular, the PLMN 200 comprises the following network functions, a Unified Data Repository (UDR), a Network Exposure Function (NEF), a Network Data Analytics Function (NWDAF) an Application Function (AF) an Policy Control Function (PCF) a Charging Function (CHF), an Access and Mobility Management Function (AMF), a Session Management Function (SMF) and a User Plane Function (UPF).

The Network Data Analytics Function (NWDAF) 301, as illustrated in FIG. 3, allows any network function 302 in the Public Land Mobile Network, for example as illustrated in FIG. 1, to request network analytics information from the NWDAF.

The Nnwdaf interface is defined for the network functions, for example, the PCF and NSSF, to: request a subscription to the delivery of analytics information for a particular context; cancel a subscription to the delivery of analytics information; and/or request a specific report of analytics information for a particular context. The analytics information may comprise, for example, a load level, and the context may comprise a network slice instance reaching a threshold load level.

The services offered by the NWDAF may be described by the following table.

TABLE 1
Services currently offered by a NWDAF in a 5G network.

| | Service | Operation | Example |
|---|---|---|---|
| Service Name | Operations | Semantics | Consumer(s) |
| Nnwdaf_EventsSubscription | Subscribe | Subscribe/ | PCF, NSSF |
| | Unsubscribe | Notify | PCF, NSSF |
| | Notify | | PCF, NSSF |
| Nnwdaf_AnalyticsInfo | Request | Request/ | PCF, NSSF |
| | | Response | |

The Nnwdaf_EventsSubscription Service enables the requesting network function (for example the PCF or NSSF) to subscribe/unsubscribe for a particular service capability. For example, the network function may subscribe to receive notifications when a threshold load in a network slice is exceeded, and/or to receive periodic notifications of the load in the network slice.

For example, the load level information may be the requested service capability, and the service request may comprise an event filter indicating which network slice instance is of interest. The request may also comprise a load level threshold value indicating that the NWDAF report is requested when the load level crosses the load level threshold value. In some examples, if no threshold is provided in the subscription request, the reporting may be assumed to be periodic.

The Nnwdaf_Analytics_Info service enables the requesting network function (for example the PCF or NSSF) to request analytics information on demand from the NWDAF. For example, the analytics information may comprise load level information of a particular Network Slice instance.

### SUMMARY

According to embodiments described herein there is provided a method, in an analytics discovery function, ADF, in a service based architecture, SBA, network comprising a network function. The method comprises receiving a request from the network function for requested analytics information; determining whether the requested analytics information matches a first registration entry; wherein the requested analytics information matches the first registration information if the request analytics information matches first analytics information in the first registration entry; and responsive to the requested analytics information matching the first registration entry, selecting the first analytics function in the first registration entry.

According to some embodiments there is provided a method, in a network function for discovery of an analytics function. The method comprises transmitting a discovery request to an analytics discovery function, ADF, the discovery request comprising requested analytics information indicative of a requested service capability; and receiving a response from the ADF comprising an identification of an analytics function capable of providing the requested service capability.

According to some embodiments there is provided a method, in an analytics function for registering the analytics function for discovery in a service based architecture, SBA, network. The method comprises transmitting a registration request to an analytics discovery function, ADF, wherein the registration request comprises analytics information indicative of a service capability that that the analytics function is capable of providing to a network function in the SBA network.

According to some embodiments there is provided an analytics discovery function, ADF, in a service based architecture, SBA, network comprising a network function. The analytics discovery function comprises processing circuitry configured to: receive a request from the network function for requested analytics information; determine whether the requested analytics information matches a first registration entry; wherein the requested analytics information matches the first registration information if the request analytics information matches first analytics information in the first registration entry; and responsive to the requested analytics information matching the first registration entry, select the first analytics function in the first registration entry.

According to some embodiments there is provided a network function in a service based architecture, SBA, network configured to discover an analytics function. The network function comprises processing circuitry configured to transmit a discovery request to an analytics discovery function, ADF, the discovery request comprising requested analytics information indicative of a requested service capability; and receive a response from the ADF comprising an identification of an analytics function capable of providing the requested service capability.

According to some embodiments there is provided an analytics function configured for registering the analytics function for discovery in a service based architecture, SBA, network. The analytics function comprises processing circuitry configured to transmit a registration request to an analytics discovery function, ADF, wherein the registration request comprises analytics information indicative of a service capability that that the analytics function is capable of providing to a network function in the SBA network.

### BRIEF DESCRIPTION OF THE DRAWINGS

FIG. 1 illustrates a service based architecture;

FIG. 2 illustrates a service based architecture for charging and analytics;

FIG. 3 illustrates a centralised Network Data Analytics Function;

FIG. 4 illustrates an example of a registration process between a first analytics function, for example an NWDAF, and an analytics data function according to some embodiments;

FIG. 5 illustrates an example of a de-registration process according to some embodiments;

FIG. 6 illustrates an example of a discovery process according to some embodiments;

FIG. 7 illustrates an example of a discovery subscription request process according to some embodiments;

FIG. 8 illustrates an example when the analytics data function acts as a proxy function according to some embodiments;

FIG. 9 illustrates an example of an Event subscription process where the analytics data function acts as a proxy function according to some embodiments;

FIG. 10 illustrates a method, in a network function for discovery of an analytics function according to some embodiments;

FIG. 11 illustrates a method, in an analytics function for registering the analytics function for discovery in a service based architecture, SBA, network according to some embodiments;

FIG. 12 illustrates a method in an analytics discovery function according to some embodiments;

FIG. 13 illustrates an analytics discovery function according to some embodiments;

FIG. 14 illustrates a network function according to some embodiments;

FIG. 15 illustrates an analytics function according to some embodiments.

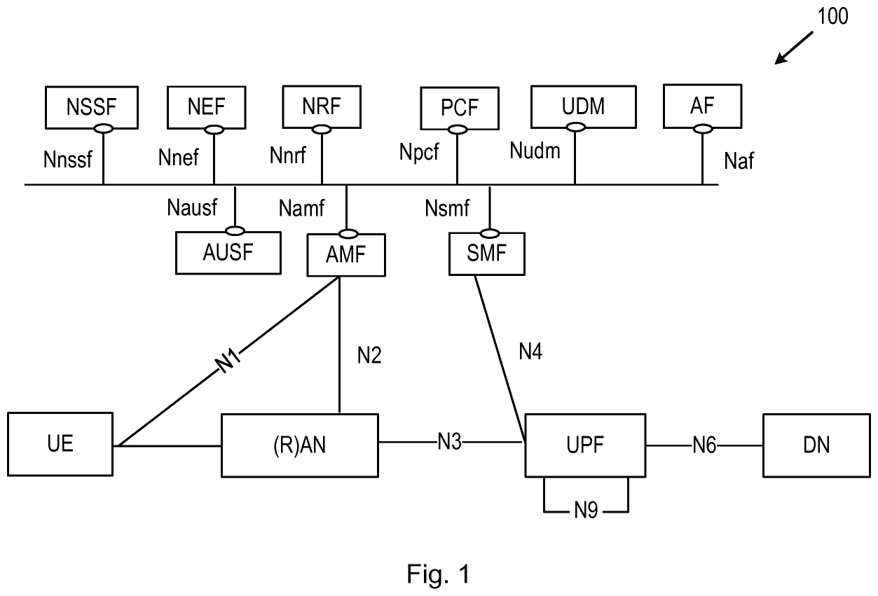

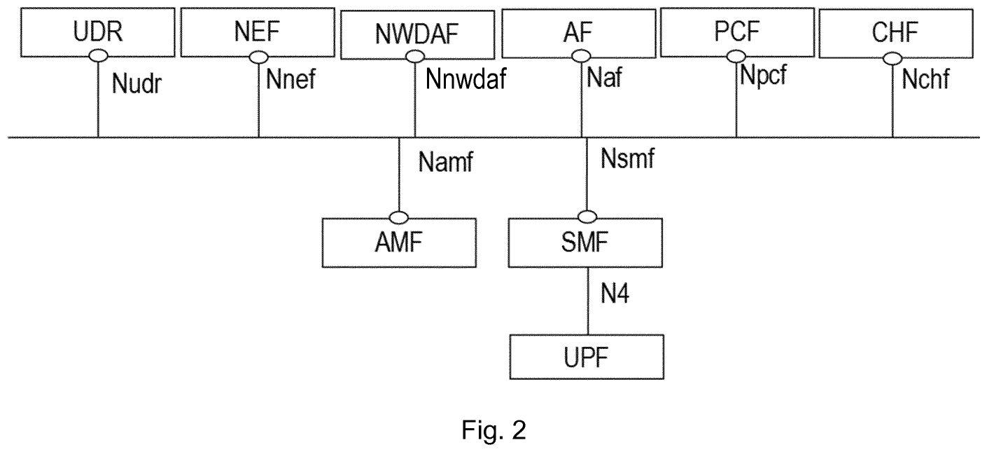

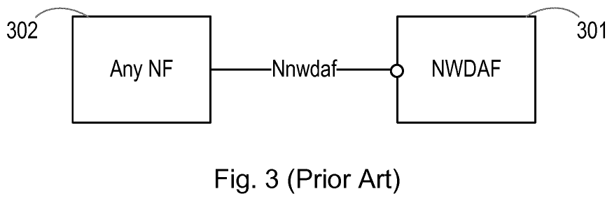

### DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In previous Service Based Architecture (SBA) development, the Network Data Analytics Function (NWDAF) has been standardized as a centralized Network Function (NF) that has vision over the whole operator's network, i.e. the whole Public Land Mobile Network (PLMN), and has previously been capable of providing insights for all users, applications, NFs, network slices, etc.

However, it may now be desirable, for instances where certain analytics may be performed by a NF independently, to have an NWDAF instance specific to that analytic, which may also be collocated with the NF.

In other words, in some examples, there may be multiple independent NWDAF instances within a PLMN, where each NWDAF instance may be capable of providing a subset of the services that were previously provided by the centralised NWDAF.

However, having many NWDAF instances with different service capabilities poses the following problems that are not addressed by the current specification. Firstly, a certain NWDAF instance may support only a subset of the standardized service capabilities (the analytics insights that the NWDAF can provide). A mechanism to discover what NWDAF instances support what service capabilities may therefore be required.

Furthermore, when subscribing to or requesting a certain service capability, the consumer NF may indicate associated filters which may comprise the conditions that the service provided may be required to meet. For example, the associated filters may comprise one or more user-IDs or application-IDs if the consumer NF is requesting the service for those specific users or applications. However, a certain NWDAF instance may handle a subset of the standardized filters (for example, may only provide a particular service for a subset of the users), so a mechanism to discover the NWDAF instances that support certain filters may also be required.

Different NWDAF instances may also have colliding service capabilities and filters. Therefore, a consumer NF that is requesting a certain service capability with certain filters may require a mechanism to resolve the collision in order to request the service from the more suitable NWDAF instance.

Embodiments provided herein therefore provide methods and apparatus for discovery of analytics functions, for example NWDAFs, in a service based architecture network.

In particular, embodiments described herein provide an Analytics Discovery Function (ADF), whose functionality may be deployed within the SBA as a standalone NF, or may be collocated with another NF in the SBA. For example, the Network Repository Function (NRF) may be extended with the functionality of the ADF as described herein.

Each NWDAF instance in the SBA network may register the services it is capable of supporting with the ADF. Then NFs in the SBA network may use the ADF to discover the different NWDAF instances that are capable of providing a certain service. The NFs may then request or subscribe to the services in the discovered NWDAF instances.

First the analytics functions in the SBA may register the services that they are capable of providing with the ADF.

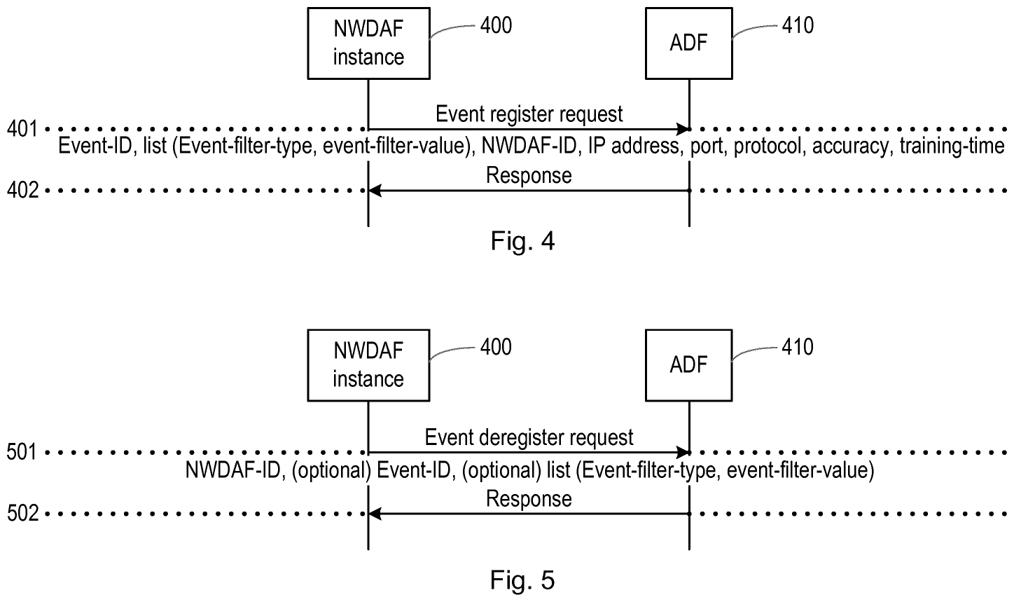

FIG. 4 illustrates an example of a registration process between a first analytics function 400, for example an NWDAF, and an ADF 410 according to some embodiments.

In step 401, the ADF 410, receives a first registration request from the first analytics function 400 in the SBA network. The first registration request comprises first analytics information indicative of a first service capability that that the first analytics function 400 is capable of providing to network functions in the SBA network.

For example, the first analytics information may comprise an Event-ID or service capability, which identifies a service that the first analytics function 400 is capable of providing. The first analytics information may further comprise supported Event-filter-types of filter types and Event-filter-values or filter values for the Event-ID. Event filter types may be for example, user-ID, Application-ID, slice-ID, node-ID, location-ID (e.g. Tracking Area ID), etc. The Event filter values may comprise a single value, a range of values, or a list of values. Filter values for a particular service capability may limit circumstances in which the particular service capability is available from the first analytics function 400.

For example, the first analytics information may specify that the Event-ID is a Load level insight, the Event-filter-type is user-ID, and the Event-filter-value is a list of users that the first analytics function 400 is capable of providing the load level insight for.

The first analytics information may further comprise one or more first characteristics associated with the analytics information. For example, one or more first characteristic comprises one or more of: a location of the first analytics function 400, an accuracy associated with the first service capability, a time at which a model, for example a machine learning model, used provide the first service capability was trained.

The ADF 410 may then store the first analytics information. For example, the ADF 410 may generate a first registration entry for the first analytics function comprising the first analytics information an identification of the first analytics function 400. The first registration entry may be stored in the ADF. The first registration entry may also be stored in the NRF or UDR.

In step 402, the ADF 410 may respond to the first analytics function 400 acknowledging the registration.

It will be appreciated, that each analytics function instance may register its service capabilities with the ADF 410, and that ADF 410 may store a registration entry for each analytics function instance. In other words, the ADF 410 may also receive a second registration request from a second analytics function in the SBA network, wherein the second registration request comprises second analytics information indicative of a second service capability that the second analytics function is capable of providing to the network function in the SBA network. The ADF 410 may then also store a second registration entry for the second analytics function comprising the second analytics information and a second identification of the second analytics function.

In some cases, the first analytics function 400 may no longer be capable of providing a particular service, for example, on deactivation of the first analytics function 400, or in a re-calibration of the first analytics function 400. In these circumstances, the analytics function 400 may de-register the service capability from the ADF 410 as illustrated in FIG. 5.

FIG. 5 illustrates an example of a de-registration process according to some embodiments.

In step 501, the ADF 410 receives a deregistration request from the first analytics function 400 comprising third analytics information. In some examples, the first analytics function 400 may request to remove all service capabilities it had previously registered with the ADF 400. However, in some examples, the first analytics function 400 may de-register only part of the services it had previously registered. For example, the first analytics function 400 may deregister a particular service capability, or may deregister only certain filter values associated with a particular service capability. The service capability and/or filters that the first analytics function 400 is deregistering may be indicated in the third analytics information received in step 501.

In some examples, if the first analytics function 400 wishes to deregister all service capabilities, no analytics information may be provided in the deregistration request. The ADF 410 may then interpret the lack of analytics information as indicating that all service capability for the first analytics function 400 is to be deregistered.

The ADF 410, may then remove the indicated service capabilities from the first registration entry for the first analytics function 400.

In step 502, the ADF 410 may transmit a response to the first analytics function 400 acknowledging the de-registration of the service capabilities.

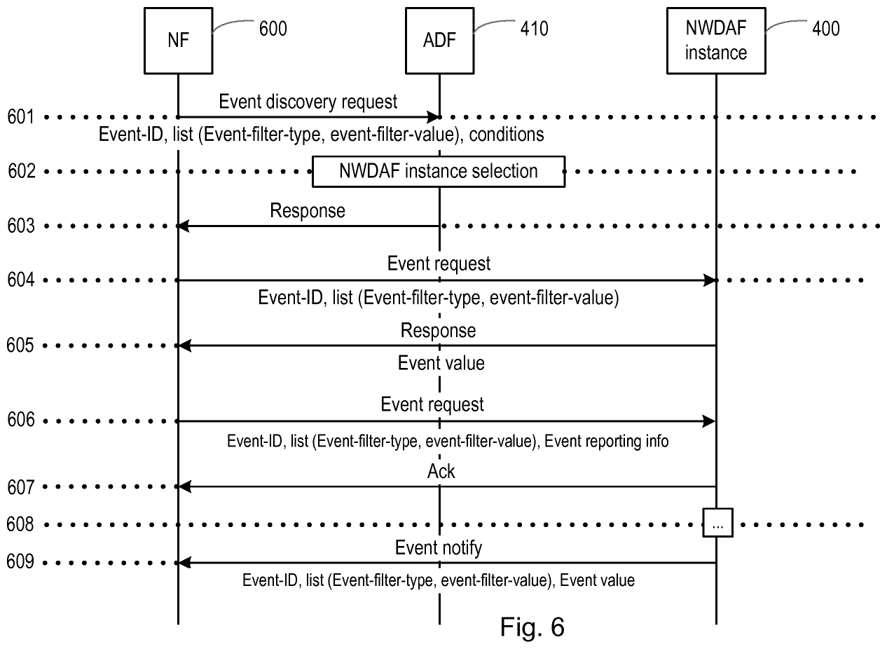

FIG. 6 illustrates an example of a discovery process according to some embodiments. In this example, the NF 600 discovers the first analytics function 400. It will be appreciated that the NF 600 may comprise any NF, including an NWDAF instance or the centralised NWDAF.

In step 601, the ADF 410 receives a request from the NF 600 for requested analytics information. In this example, the request comprises an Event discovery request, or a discovery request. The requested analytics information may comprise a requested service capability (Event-ID), a requested filter type (Event-filter-type), a requested filter value (Event-filter-value) and one or more requested criterion.

A requested criterion may comprise a criterion regarding the model accuracy of a model used by an analytics function to provide the requested service. For example, the requested criterion may indicate that the most accurate model is requested, or that the accuracy of the model must be over a certain threshold.

A requested criterion may comprise a criterion regarding the last training time of the model used by the analytics function to provide the requested service. For example, the requested criterion may indicate that the analytics function with the most recently trained model is requested, or that only analytics functions using models trained after a certain point in the past should be provided.

This requested criterion allows the NF 600 to avoid using outdated ML models in analytics functions (i.e. those that have not been retrained recently and the data dynamicity may have made them unsuitable to make predictions), by setting a criterion in the requested analytics information to select analytics functions having models which were trained more recently.

A requested criterion may comprise a criterion regarding a location of the analytics function. For example, the criterion may indicate that the analytics function should be collocated with the requesting NF, or close to the requesting NF. For example, the ADF 410 may utilise a “topology map” of the network. This “topology map” may be generated by mapping a location identifier/name/address (e.g. IP addresses or FQDN—Full Qualified Domain Names) to NF instances (including NWDAF instances). Then the location of the requestor NF may be used together with the topology map to select NWDAF instances that share the same or close locations.

In step 602, the ADF 410 determines whether the requested analytics information matches any of the stored registration entries; wherein the requested analytics information matches a registration entry if the request analytics information matches analytics information in the registration entry. Responsive to the requested analytics information matching the first registration entry, the ADF selects the first analytics function 400 in the first registration entry.

Step 602 may comprise determining whether a requested service capability indicated by the requested analytics information is the same as the first service capability. In particular, the ADF 410 may determine whether the requested service capability is the same as the service capabilities indicated in any of the stored registration entries.

Step 602 may also comprise determining whether a requested filter value in the requested analytics information is the same as the first filter value. In particular, for registration entries whether the requested service capability is matched, the ADF 410 may determine if the filter values for the service capabilities stored in the registration entries also match the requested filter values.

Step 602 may further comprise determining whether the first characteristic meets one or more requested criterions in the requested analytics information. The ADF 410 may therefore determine for registration entries where both the service capability and filter values are matched, whether the requested criterion are also met, based on the characteristics stored in the registration entries.

Different requested criterion may be provided in the requested analytics information as a prioritized list. So, criterion with higher priority may be evaluated first by the ADF 410 to check if they can be fulfilled, and if this is not the case the criterion may be evaluated in order until a matching criterion is found. In this example, a registration entry may match the requested analytics information if only one of the requested criterion is met. However, a registration entry may be considered more suitable for the NF 600 if a criterion of a higher priority is met.

In some examples, if no stored registration entry matches the requested analytics information no analytics function instance is selected. In some examples, more than one registration entry matches the requested analytics information. In these examples, more than one analytics function may be selected from those registration entries that match the requested analytics information.

In step 603 the ADF 410 transmits a response to the NF 600 comprising a first identification of the first analytics function 400. In examples, where more than one analytics function is selected in step 602, the ADF 410 may transmit a response to the NF 600 comprising identifications of a plurality of analytics functions from the plurality of registration entries selected. Alternatively, the ADF 410 may select the first analytics function 400 from the selected analytics functions and transit the response to the NF 600 comprising the first identification of the first analytics function 400.

For example, the response may comprise an NWDAF-ID, IP address, port and protocol of the selected analytics function(s).

If no analytics function is selected, a failure indication may be sent to the NF 600 including the reason for the failure, for example: no matching analytics function for the requested criterion, no analytics function instance supports the requested Event-ID or Event filters, etc.

Once the NF 600 has discovered the first analytics function 400, it may request the service by means of a request/response type of interaction.

For example, in step 604, the NF 600 transmits to the first analytics function 400 an Event request message including the Event-ID and the list of Event-filter-types and Event-filter-values.

In step 605, the first analytics function 400, responds with the Event value, i.e. the requested service is fulfilled.

Alternatively or additionally the NF 600 may transmit a subscription request to the first analytics function 400 to subscribe to the requested service.

For example, in step 606, the NF 600 transmits an Event subscribe message to the first analytics function 400, comprising the Event-ID, the list of Event-filter-types and Event-filter-values, and the event reporting information (i.e. when to send the Event notifications to the NF 600, e.g. periodically, when reaching a threshold, etc.)

In step 607, the first analytics function 400 acknowledges the subscription request

In step 608 either the requested periodicity for reporting elapses, or an event occurs to trigger the subscription.

In step 609 the first analytics function 400 transmits an Event notify message to the NF 600 comprising the Event-ID, the list of Event-filter-types and Event-filter-values associated to the Event-ID, and the Event value.

It will be appreciated that each NF in the SBA network may transmit service requests to a plurality of different analytics functions, and the analytics functions may provide services to a number of different NFs.

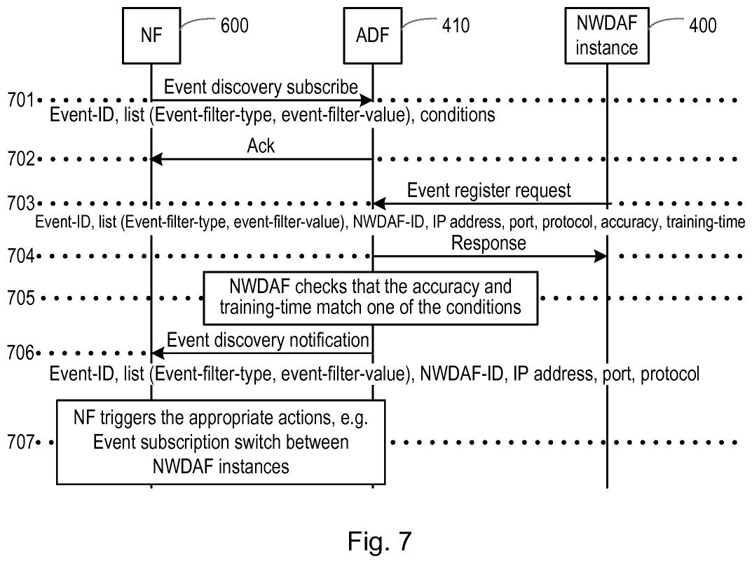

FIG. 7 illustrates an example of a discovery subscription request process according to some embodiments.

In step 701, the NF 600 transmits an Event discovery subscribe message to the ADF 410.

The Event discovery subscribe message may comprise requested analytics information. Similarly to as described with reference to FIG. 6, the requested analytics information may comprise the service capability (i.e. Event-ID) that the NF 600 wishes to subscribe to. The Event discovery subscribe message may also comprise a list of filter types (Event-filter-types) and filter values (Event-filter-values) associated to with the service capability.

The requested analytics information may also comprise one or more requested criterion that the selected analytics function, similarly to as described with reference to FIG. 6.

In step 702, the ADF 410 acknowledges the Event discovery subscribe message

In some examples, as described in FIG. 6, the ADF 410 may select an analytics function based on the received conditions and provide an identification of the analytics function, and for example, an IP address in the acknowledgement message in step 702.

In step 703, a new analytics function 700 registers new analytics information, for example, as illustrated in FIG. 4.

In step 704, the ADF 410, responds to the new analytics function 700 acknowledging the registration.

As the NF 600 has subscribed to the discovery of analytics functions, the ADF 410 in step 705, checks whether the new analytics information matches the requested analytics information received in step 701. For example, the ADF 410 may check that the requested service capability is the same as the service capability indicated in the new analytics information, that the requested filter values are the same as the filter values in the new analytics information, and that any characteristics in the new analytics information, for example the accuracy and training time, meet any requested criterion in requested analytics information.

Responsive to the new analytics information matching the requested analytics information the ADF 410 may transmit an Event discovery notification message in step 705.

The Event discovery notification message may comprise the new analytics information. For example, the Event-ID, the list of Event-filter-types and Event-filter-values associated to the Event-ID, the NWDAF-ID, IP address, port and protocol of the new registered analytics function 700.

In step 706 then the NF 600 may then trigger any appropriate actions, which may be for example, starting an Event subscription towards the new analytics function 700, or changing an existing Event subscription from one analytics function to the new analytics function 700, and/or requesting an on demand service from the analytics function 700.

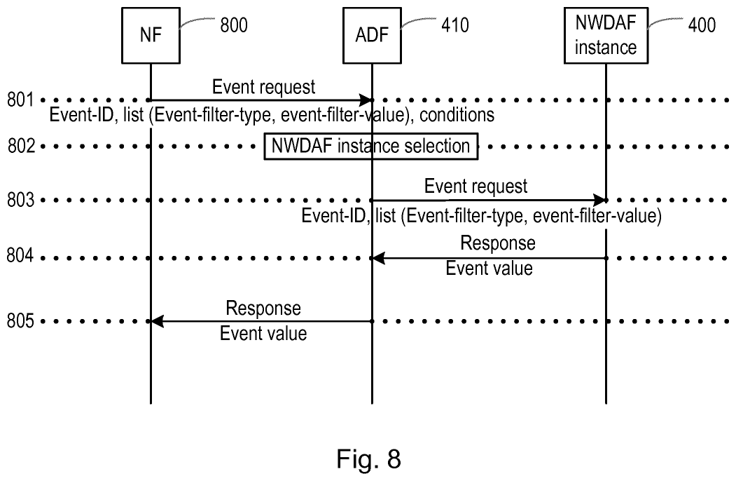

FIG. 8 illustrates an example when the ADF 410 acts as a proxy function according to some embodiments. In this example, the NF 800 may be unaware of the existence of multiple analytics function instances within the network. It may instead treat the ADF 410 as the centralised analytics function.

In step 801, the ADF 410 receives a service request from the NF 800. The service request comprises requested analytics information, as previously described. In step 802, the ADF 410 determines whether the requested analytics information matches any of the registration entries stored by the ADF 410.

Based on the one or more registration entries that match the requested analytics information, the ADF 410 may in step 802 select one of the analytics function from among the matching registration entries. If no analytics function is selected, a failure indication may be transmitted to the NF 800, including the reason for the failure. In this example, the first analytics function 400 is selected.

In step 803, the ADF 410 sends an Event Request message to the selected analytics function 400 including the requested analytics information, for example, the Event-ID, the list of Event-filter-types and Event-filter-values associated to the Event-ID. In other words, the ADF 410 forward the service request received from the NF 800 to the first analytics function 400.

In step 804, the first analytics function 400 transmits a response to the service request to the ADF 410. The ADF 410 may then forward the received response to the NF 800 in step 805.

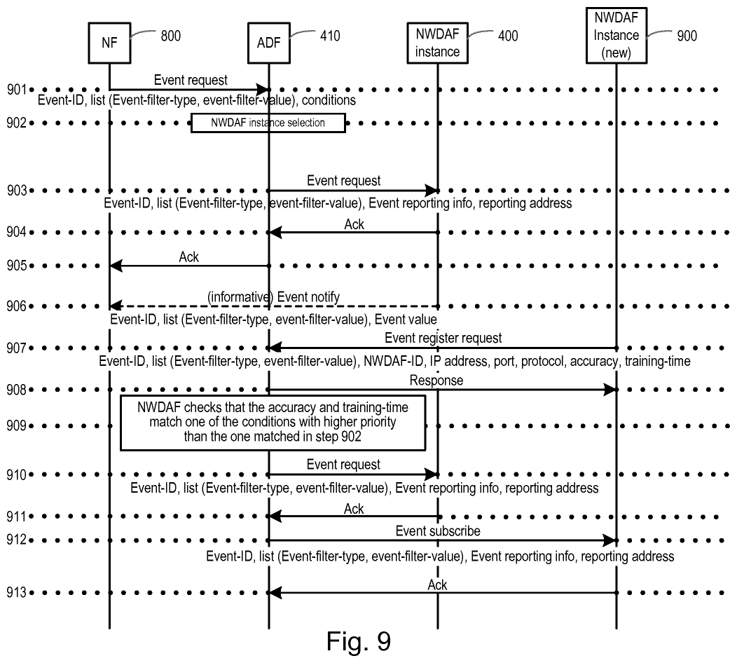

FIG. 9 illustrates an example of an Event subscription process where the ADF 410 acts as a proxy function according to some embodiments. Similarly to as in FIG. 8, in this example, the NF 800 may be unaware of the multiple analytics function instances within the network, and may treat the ADF 410 as a proxy function.

In step 901 the ADF 410 receives an Event subscription request comprising request analytics information. As previously described, the request analytics information may comprise the Event-ID, the list of Event-filter-types and Event-filter-values, the event reporting information (i.e. when to send the Event notifications to the NF, e.g. periodically, when reaching a threshold, etc.) and the requested criterion.

Based on the one or more registration entries that match the requested analytics information, the ADF 410 may in step 902 select one of the analytics functions from among the matching registration entries. If no analytics function is selected, a failure indication may be transmitted to the NF 800, including the reason for the failure. In this example, the first analytics function 400 is selected.

In step 903, the ADF 410 forwards the Event subscription request to the selected analytics function, which in this example comprises the first analytics function 400. In some examples, the Event subscription request may be transmitted with an address of the NF 800 address as the reporting address (so that the NWDAF instance can send the Event notifications directly to the NF). For example, the ADF 410 may extract the address of the NF 800 from an IP header Event subscription request received in step 901.

In step 904, the first analytics function 401 acknowledges the Event subscription request to the ADF 410. In step 905, the ADF 410 forwards the acknowledgment to the NF 800.

At this point the first analytics function 400 is set up to send Event notifications, as illustrated in step 906, to the NF 800 according to the requested subscription, as described in more detail with reference to steps 608 and 609 in FIG. 6.

In step 907, a new analytics function 900 sends a registration request to the ADF 410, for example as illustrated in FIG. 4.

In step 908, the ADF 410 responds to the new analytics function 900 acknowledging the registration of the analytics information that the new analytics information is capable of providing.

In step 909, the ADF 410 checks whether the requested analytics information matches the new registration entry formed for the new analytics function 900. In particular, the ADF 410 may determine whether the requested analytics information matches the new registration entry more closely than the first registration entry. For example, the new analytics information may indicate a model accuracy and model training-time that matches one of the requested criterion with higher priority than the requested criterion matched in step 902 when the first analytics function 400 was selected. The ADF 410 may then decide to switch the subscription from the first analytics function 400 to the new analytics function 900.

In step 910 the ADF 410 may then transmit an Event unsubscribe request to the first analytics function 400 comprising the requested analytics information. Based on the requested analytics information the first analytics function 400 may then un-subscribe the service to the NF 800.

In step 911, the first analytics function 400 may transmit, to the ADF 410, an acknowledgment of the un-subscription of the service to the NF 800.

In step 912, the ADF 410 may transmit an Event subscription request comprising the requested analytics information to the new analytics function 900. The Event subscription request may be the same as the event subscription request transmitted in step 904.

In step 913, the new analytics function 900 may transmit, to the ADF 410, an acknowledgement of the subscription of the requested service to the NF 800.

In some examples, the same process to switch subscriptions from one analytics function to another analytics function may take place when a first analytics function transmits an Event deregister request, as illustrated in FIG. 5. For example, if after step 913, the new analytics function 900 deregisters the new analytics information registered in step 907, the ADF 410 may re-select an analytics function from stored the registration entries, and may switch the subscription to a selected analytics function, which may be the first analytics function, or may be a different analytics function. In some examples, the selected analytics function may comprise the analytics function which best matches the requested criterion.

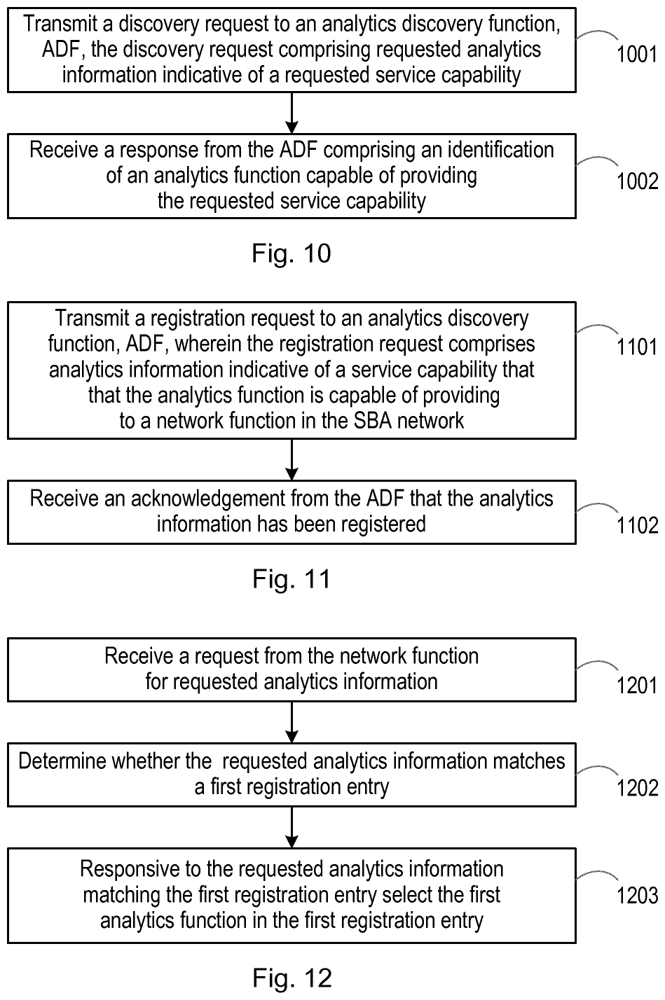

FIG. 10 illustrates a method, in a network function for discovery of an analytics function according to some embodiments.

In step 1001, the network function transmits a discovery request to an analytics discovery function, ADF, the discovery request comprising requested analytics information indicative of a requested service capability. The discovery request may comprise a service discovery request, as illustrated in step 601 of FIG. 6, or a service subscription discovery request, as illustrated in step 701 of FIG. 7.

In step 1002, the network function receives a response from the ADF comprising an identification of an analytics function capable of providing the requested service capability. For example, the response illustrated in step 603 of FIG. 6, or the response illustrated in step 706 of FIG. 7.

In some examples, the response comprises a plurality of identifications of a plurality of analytics functions. In this case, the network function may be configured to select one of the plurality of analytics functions, and transmit a service request to the selected one of the plurality of analytics functions. The selection may be based on how well analytics information associated with the analytics functions meets requested criterion.

FIG. 11 illustrates a method, in an analytics function for registering the analytics function for discovery in a service based architecture, SBA, network.

In step 1101, the analytics function transmits a registration request to an analytics discovery function, ADF, wherein the registration request comprises analytics information indicative of a service capability that that the analytics function is capable of providing to a network function in the SBA network.

In some examples, in step 1102, the analytics function receives an acknowledgement from the ADF that the analytics information has been registered.

FIG. 12 illustrates a method, in an analytics discovery function, ADF, in a service based architecture, SBA, network comprising a network function.

In step 1201, the ADF receives a request from the network function for requested analytics information.

In step 1202, the ADF determines whether the requested analytics information matches a first registration entry; wherein the requested analytics information matches the first registration information if the request analytics information matches first analytics information in the first registration entry.

In step 1203, responsive to the requested analytics information matching the first registration entry, the ADF selects the first analytics function in the first registration entry.

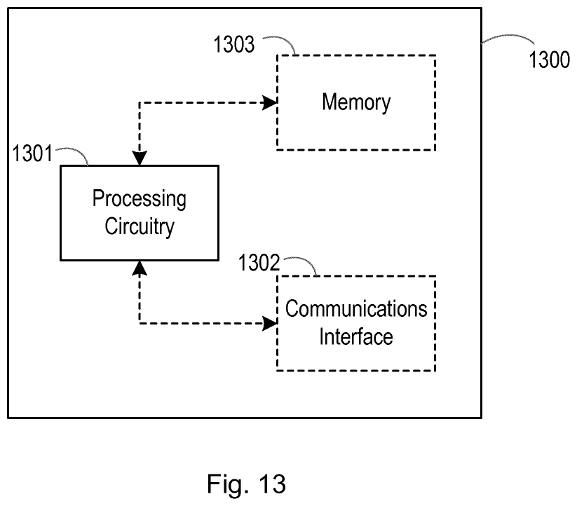

FIG. 13 illustrates an analytics discovery function 1300 comprising processing circuitry (or logic) 1301. The processing circuitry 1301 controls the operation of the analytics discovery function 1300 and can implement the method described herein in relation to an analytics discovery function 1300. The processing circuitry 1301 can comprise one or more processors, processing units, multi-core processors or modules that are configured or programmed to control the analytics discovery function 1300 in the manner described herein. In particular implementations, the processing circuitry 1301 can comprise a plurality of software and/or hardware modules that are each configured to perform, or are for performing, individual or multiple steps of the method described herein in relation to the analytics discovery function 1300.

Briefly, the processing circuitry 1301 of the analytics discovery function 1300 is configured to receive a request from the network function for requested analytics information; determine whether the requested analytics information matches a first registration entry; wherein the requested analytics information matches the first registration information if the request analytics information matches first analytics information in the first registration entry; and responsive to the requested analytics information matching the first registration entry, select the first analytics function in the first registration entry.

In some embodiments, the analytics discovery function 1300 may optionally comprise a communications interface 1302. The communications interface 1302 of the analytics discovery function 1300 can be for use in communicating with other nodes, such as other virtual nodes. For example, the communications interface 1302 of the analytics discovery function 1300 can be configured to transmit to and/or receive from other nodes requests, resources, information, data, signals, or similar. The processing circuitry 1301 of the analytics discovery function 1300 may be configured to control the communications interface 1302 of the analytics discovery function 1300 to transmit to and/or receive from other nodes requests, resources, information, data, signals, or similar.

Optionally, the analytics discovery function 1300 may comprise a memory 1303. In some embodiments, the memory 1303 of the analytics discovery function 1300 can be configured to store program code that can be executed by the processing circuitry 1301 of the analytics discovery function 1300 to perform the method described herein in relation to the analytics discovery function 1300. Alternatively or in addition, the memory 1303 of the analytics discovery function 1300, can be configured to store any requests, resources, information, data, signals, or similar that are described herein. The processing circuitry 1301 of the analytics discovery function 1300 may be configured to control the memory 1303 of the analytics discovery function 1300 to store any requests, resources, information, data, signals, or similar that are described herein.

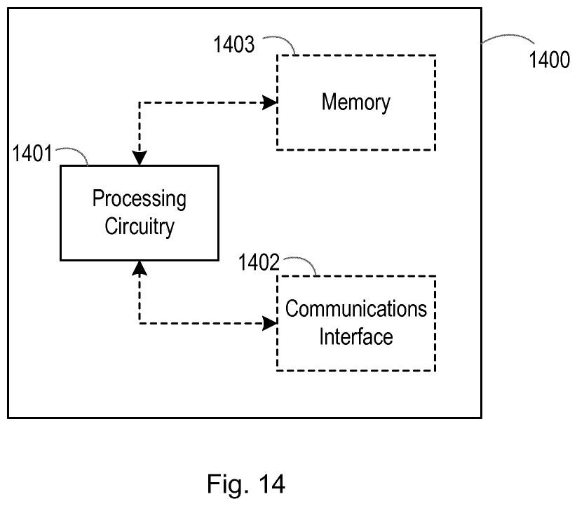

FIG. 14 illustrates a network function 1400 comprising processing circuitry (or logic) 1401. The processing circuitry 1401 controls the operation of the network function 1400 and can implement the method described herein in relation to a network function 1400. The processing circuitry 1401 can comprise one or more processors, processing units, multi-core processors or modules that are configured or programmed to control the network function 1400 in the manner described herein. In particular implementations, the processing circuitry 1401 can comprise a plurality of software and/or hardware modules that are each configured to perform, or are for performing, individual or multiple steps of the method described herein in relation to the network function 1400, for example NF 600 or NF 800.

Briefly, the processing circuitry 1401 of the network function 1400 is configured to transmit a discovery request to an analytics discovery function, ADF, the discovery request comprising requested analytics information indicative of a requested service capability; and receive a response from the ADF comprising an identification of an analytics function capable of providing the requested service capability.

In some embodiments, the network function 1400 may optionally comprise a communications interface 1402. The communications interface 1402 of the network function 1400 can be for use in communicating with other nodes, such as other virtual nodes. For example, the communications interface 1402 of the network function 1400 can be configured to transmit to and/or receive from other nodes requests, resources, information, data, signals, or similar. The processing circuitry 1401 of the network function 1300 may be configured to control the communications interface 1402 of the network function 1400 to transmit to and/or receive from other nodes requests, resources, information, data, signals, or similar.

Optionally, the network function 1400 may comprise a memory 1403. In some embodiments, the memory 1403 of the network function 1400 can be configured to store program code that can be executed by the processing circuitry 1401 of the network function 1400 to perform the method described herein in relation to the network function 1400. Alternatively or in addition, the memory 1403 of the network function 1400, can be configured to store any requests, resources, information, data, signals, or similar that are described herein. The processing circuitry 1401 of the network function 1400 may be configured to control the memory 1403 of the network function 1400 to store any requests, resources, information, data, signals, or similar that are described herein.

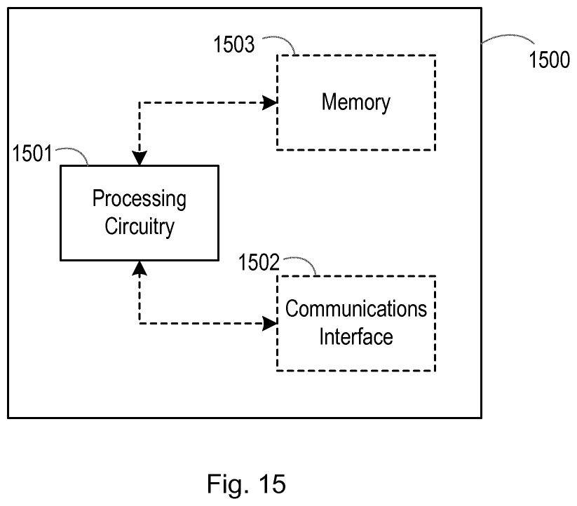

FIG. 15 illustrates an analytics function 1500 comprising processing circuitry (or logic) 1501. The processing circuitry 1501 controls the operation of the analytics function 1500 and can implement the method described herein in relation to an analytics function 1500, for example analytics function 400, 700 or 900. The processing circuitry 1501 can comprise one or more processors, processing units, multi-core processors or modules that are configured or programmed to control the analytics function 1500 in the manner described herein. In particular implementations, the processing circuitry 1501 can comprise a plurality of software and/or hardware modules that are each configured to perform, or are for performing, individual or multiple steps of the method described herein in relation to the analytics function 1500.

Briefly, the processing circuitry 1501 of the analytics function 1500 is configured to transmit a registration request to an analytics discovery function, ADF, wherein the registration request comprises analytics information indicative of a service capability that that the analytics function is capable of providing to a network function in the SBA network.

In some embodiments, the analytics function 1500 may optionally comprise a communications interface 1502. The communications interface 1502 of the analytics function 1500 can be for use in communicating with other nodes, such as other virtual nodes. For example, the communications interface 1502 of the analytics function 1500 can be configured to transmit to and/or receive from other nodes requests, resources, information, data, signals, or similar. The processing circuitry 1501 of the analytics function 1500 may be configured to control the communications interface 1502 of the analytics function 1500 to transmit to and/or receive from other nodes requests, resources, information, data, signals, or similar.

Optionally, the analytics function 1500 may comprise a memory 1503. In some embodiments, the memory 1503 of the analytics function 1500 can be configured to store program code that can be executed by the processing circuitry 1501 of the analytics function 1500 to perform the method described herein in relation to the analytics function 1500. Alternatively or in addition, the memory 1503 of the analytics function 1500, can be configured to store any requests, resources, information, data, signals, or similar that are described herein. The processing circuitry 1501 of the analytics function 1500 may be configured to control the memory 1403 of the analytics function 1500 to store any requests, resources, information, data, signals, or similar that are described herein.

There is therefore provided methods and apparatus in a Service Based Architecture, SBA, for enabling discovery of analytics functions such as NWDAF functions.

Embodiments described herein further allow for the ADF use the training time and accuracy of models used to provide the service in the analytics functions in order to select which analytics function to provide to the requesting NF.

Embodiments described herein also allow NFs to specify the criterion they wish to be applied when selecting NWDAF instances. For example, some NFs may prioritize some characteristics of the analytics function over other characteristics.

Embodiments described herein also allow the network functions to avoid using outdated ML models analytics functions (i.e. those that have not been retrained recently and the data dynamicity may have made them unsuitable to make predictions), by setting a criterion in the requested analytics information to select analytics functions having models which were trained more recently.

Embodiments described herein also allow the ADF to consider the accuracy changes when models are retrained, and to handle NWDAF instances or containerized analytics services embedded in the NFs.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method, in an analytics discovery function, ADF, in a service based architecture, SBA, network comprising a network function, the method comprising:
receiving a request from the network function for requested analytics information;
determining whether the requested analytics information matches a first registration entry; wherein the requested analytics information matches the first registration entry if the requested analytics information matches first analytics information in the first registration entry; and
responsive to the requested analytics information matching the first registration entry, selecting the first analytics function in the first registration entry.

2. The method as claimed in claim 1 further comprising:
receiving a first registration request from a first analytics function in the SBA network, wherein the first registration request comprises first analytics information indicative of a first service capability that the first analytics function is capable of providing to the network function, and
storing the first registration entry comprising the first analytics information and a first identification of the first analytics function.

3. The method as in claimed in claim 2 further comprising:
receiving a second registration request from a second analytics functions in the SBA network, wherein the second registration request comprises second analytics information indicative of a second service capability that the second analytics function is capable of providing to the network function in the SBA network, and
storing a second registration entry for the second analytics functions comprising the second analytics information and a second identification of the second analytics function.

4. (canceled)

5. (canceled)

6. The method as claimed in claim 2 wherein the step of determining whether the requested analytics information matches the first registration entry comprises determining whether a requested service capability indicated by the requested analytics information is the same as the first service capability.

7. The method as claimed in claim 6 wherein the first analytics information comprises a first filter value limiting circumstances in which the first service capability is available from the first analytics function.

8. (canceled)

9. The method as claimed in claim 7 wherein the first filter value comprises one or more of: at least one user identification value and at least one application identification value.

10. The method as claimed in claim 1 wherein the first analytics information comprises a first characteristic associated with the first analytics information.

11. The method as claimed in claim 10 wherein the first characteristic comprises one or more of: a location of the first analytics function, an accuracy associated with the first service capability, a time at which a model used provide the first service capability was trained.

12. The method as claimed in claim 10 wherein the step of determining whether the requested analytics information matches the first registration entry comprises determining whether the first characteristic meets a requested criterion in the requested analytics information.

13. The method as claimed in claim 12 wherein the requested criterion comprises one or more of: a location of the ADF with respect to the network function, a minimum accuracy, a maximum age.

14-16. (canceled)

17. A method, in a network function for discovery of an analytics function, the method comprising:
transmitting a discovery request to an analytics discovery function, ADF, the discovery request comprising requested analytics information indicative of a requested service capability; and
receiving a response from the ADF comprising an identification of an analytics function capable of providing the requested service capability.

18. The method as claimed in claim 17 further comprising transmitting a service request to the analytics function.

19. The method as claimed in claim 17 wherein the response comprises a plurality of identifications of a plurality of analytics functions capable of providing the requested service capability, and wherein the method further comprises:
selecting one of the plurality of analytics functions, and
transmitting a service request to the selected one of the plurality of analytics functions.

20. A method, in an analytics function for registering the analytics function for discovery in a service based architecture, SBA, network, the method comprising:
transmitting a registration request to an analytics discovery function, ADF, wherein the registration request comprises analytics information indicative of a service capability that the analytics function is capable of providing to a network function in the SBA network.

21. An analytics discovery function, ADF, in a service based architecture, SBA, network comprising a network function, the analytics discovery function comprising processing circuitry configured to:
receive a request from the network function for requested analytics information;
determine whether the requested analytics information matches a first registration entry; wherein the requested analytics information matches the first registration entry if the requested analytics information matches first analytics information in the first registration entry; and
responsive to the requested analytics information matching the first registration entry, select the first analytics function in the first registration entry.

22. The ADF as claimed in claim 21 wherein the processing circuitry is further configured to:
receive a first registration request from a first analytics function in the SBA network, wherein the first registration request comprises first analytics information indicative of a first service capability that the first analytics function is capable of providing to the network function, and
store the first registration entry comprising the first analytics information and a first identification of the first analytics function.

23. The ADF as in claimed in claim 22 wherein the processing circuitry is further configured to:
receive a second registration request from a second analytics functions in the SBA network, wherein the second registration request comprises second analytics information indicative of a second service capability that the second analytics function is capable of providing to the network function in the SBA network, and
store a second registration entry for the second analytics functions comprising the second analytics information and a second identification of the second analytics function.

24. (canceled)

25. (canceled)

26. The ADF as claimed in claim 22 wherein processing circuitry is configured to determine whether the requested analytics information matches the first registration entry by determining whether a requested service capability indicated by the requested analytics information is the same as the first service capability.

27. The ADF as claimed in claim 26 wherein the first analytics information comprises a first filter value limiting circumstances in which the first service capability is available from the first analytics function.

28. (canceled)

29. The ADF as claimed in claim 27 wherein the first filter value comprises one or more of: at least one user identification value and at least one application identification value.

30. The ADF as claimed in claim 21 wherein the first analytics information comprises a first characteristic associated with the first analytics information.

31. The ADF as claimed in claim 30 wherein the first characteristic comprises one or more of: a location of the first analytics function, an accuracy associated with the first service capability, a time at which a model used provide the first service capability was trained.

32. The ADF as claimed in claim 30 wherein the processing circuitry is configured to determine whether the requested analytics information matches the first registration entry by determining whether the first characteristic meets a requested criterion in the requested analytics information.

33. The ADF as claimed in claim 32 wherein the requested criterion comprises one or more of: a location of the ADF with respect to the network function, a minimum accuracy, a maximum age.

34-36. (canceled)

37. A network function in a service based architecture, SBA, network configured to discover an analytics function, the network function comprising processing circuitry configured to:
transmit a discovery request to an analytics discovery function, ADF, the discovery request comprising requested analytics information indicative of a requested service capability; and
receive a response from the ADF comprising an identification of an analytics function capable of providing the requested service capability.

38. The network function as claimed in claim 37 wherein the processing circuitry is further configured to transmit a service request to the analytics function.

39-43. (canceled)
